(19) United States
(12) Patent Application Publication
(10) Pub. No.: US 2015/0348070 A1
(43) Pub. Date: Dec. 3, 2015

(54) INDEXING SOCIAL RESPONSE TO MEDIA

(71) Applicant: Participant Media, LLC, Beverly Hills, CA (US)

(72) Inventor: Chad Boettcher, Beverly Hills, CA (US)

(21) Appl. No.: 14/729,945

(22) Filed: Jun. 3, 2015

Related U.S. Application Data
(60) Provisional application No. 62/006,973, filed on Jun. 3, 2014.

(51) Int. Cl. G06Q 30/02

(52) U.S. Cl. CPC G06Q 30/0203

(57) ABSTRACT

In one embodiment, the invention relates to measuring the impact of media based on examining viewership data, social conversation, viewer response, and other metrics, and applying an algorithm that produces an index value representative of the social response to a particular media piece. For example, the participant index (TPI) provides insights about what an audience learns (knowledge), feels (attitudes and opinions) and does (behaviors and actions) in response to viewing different kinds of entertainment.

### CROSS REFERENCE TO RELATED APPLICATION

This application claims the benefit of U.S. Provisional Patent Application No. 62/006,973, filed Jun. 3, 2014.

### TECHNICAL FIELD

The present disclosure relates generally to media response, and, more particularly, to systematically measuring social response to media.

### BACKGROUND

Though much of today's media industry is solely focused on increased revenue, certain media companies pursue two critical goals: to both entertain and influence. Whether in feature films, documentaries, television programming, digital efforts, or associated social action campaigns, the pursuit of those twin goals demands a thoughtful, intelligent approach to virtually every step along the creative path, from idea to execution. Such companies or related organizations thus seek to gather real insights about the audience—everything from who they are and what they watch to how they respond to certain programs and messages, what moves them, what influences them, and what motivates them to act.

In particular, when media companies seek active engagement, and to inspire social change, it can be difficult to measure how the media shifts audience attitude and behavior. For instance, when comparing the impacts of three different films/videos about teaching, which one was most effective? And why? Also, is it always true that the perceived impact of fiction entertainment (films, videos, TV shows, etc.) is less than that of non-fiction entertainment (news, documentaries, talk shows, etc.) in regards to media coverage, public opinion, a person's attitude/behavior, or public policy?

There remains a need, therefore, to provide such “double bottom-line” companies with a simple, effective metric that will help determine, in a meaningful way, the impact of their media efforts, allowing the companies to measure the success of a project. That is, a need remains for a return-on-investment (ROI) measure that incorporates social good, not just financial return, for entertainment that inspires social change.

### SUMMARY OF THE INVENTION

According to one or more embodiments herein, a computed unit called “The Participant Index” (TPI) measures the social impact entertainment has on its audience, and specifically, on the audience's interaction with a core social issue, and is based generally on collected viewership data, audience opinion data, social media conversations, and/or behavior (action) data. The TPI, in particular, measures the reach and impact of a collection of media sources or “properties” (film, documentary, TV, and online video titles) during each computational instance (e.g., “wave”). In this manner, the TPI provides insights about what an audience learns (knowledge), feels (attitudes) and does (behaviors and actions) in response to viewing different kinds of entertainment, such as narrative film, documentary film, TV (narrative and reality/unscripted), and short online video (narrative, documentary, branded entertainment, corporate social responsibility (CSR)) content.

Accordingly, the invention relates to measuring the impact of media based on examining viewership data, social conversation, viewer response, and other metrics, and applying an algorithm that produces an index value representative of the social response to a particular media piece.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of collected data;

FIG. 2 illustrates an example of the participant index (TPI) survey questions;

FIG. 3 illustrates an example of a particular property and the valuable assessments afforded by the techniques herein, including the TPI;

FIG. 4 illustrates an example computing system architecture; and

FIG. 5 is a flow chart for the method performed in accordance with the invention.

### DESCRIPTION OF EXAMPLE EMBODIMENTS

The Participant Index (TPI) is a media-impact research system that compiles digital data and audience survey data to assess the “social impact” (how much a title “moves” a viewer—whether emotionally or behaviorally) and “buzz” creation (a title's ability to generate social media conversation) from various types of entertainment media content, such as narrative film, documentary film, TV (narrative and reality/unscripted), and short online video (narrative, documentary, public service announcements (PSAs)), and so on. With continued use, the TPI, along with additional mixed research methods, may be used to examine social impact in multiple ways. In particular, the TPI is designed explicitly to help examine the answer to this equation:
[X] entertainment property→
Led to/is correlated with [Y] effect (social action) on→
[Z] social issue=SOCIAL IMPACT

A comprehensive “social actions” scale is a key component of the TPI viewer survey, and it includes levels of social actions (on identified social issues) taken by viewers of particular entertainment properties along a continuum of:
Seeking Information→
Sharing Information→
Taking Individual Action→
Encouraging Community Action

Generally, social issues can be any issues of interest, whether past, present, or future. Examples may include addiction, body image, bullying, data and online privacy, democracy around the world, economic inequality, education for girls around the world, families dealing with loved ones in prison, family affairs, food sustainability, homelessness in America, hunger in America, mental health, mentoring at-risk young people, natural gas and fracking, prison sentencing reform, race relations, religious tolerance, sexual abuse in the catholic church, teaching, teen pregnancy, and so on.

According to the techniques herein, therefore, the participant index (TPI) may consist generally of two main elements, “narrative involvement”—also known as emotional involvement or emotion—and social actions/behavior, where, as described in greater detail below, these two components may be used to compute TPI. In addition, various other metrics are derived and computed from the TPI system, such as “buzz” creation or “knowledge” creation, among others, that may also be included in the computation, as also described below.

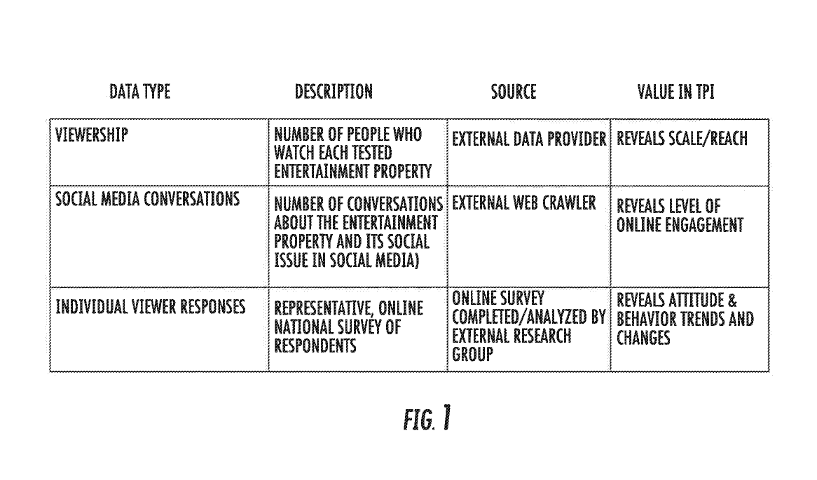

With reference to FIG. 1, TPI's core model incorporates three kinds of data: viewership, social media conversations, and individual viewer responses. From this information, the techniques herein may compute a “scale” value for each selection of media content (also referred to herein as a “title” or “property”), which answers how many viewers of the content were there, and who were they? This information may be based on viewership (box office, TV, DVD, streaming, other), demographics (age, gender, ethnicity, etc.), geography (by zip code), political affiliation (Democrat, Republican, Independent), social affiliation (religious organizations, sports and hobby groups, volunteer organizations, etc.), media habits (internet, TV, movies, PC/MAC, mobile, etc.), and so on. One particular source of scale data is social “volume,” which may be a quantification of a series of issues and influencers (e.g., collected via a web crawler scraping public data (open APIs), such as from TWITTER, FACEBOOK, YOUTUBE, INSTAGRAM, FLICKR, VIMEO, etc.). In general, the social volume may represent a number of social actions (posts, images, comments, etc.) that involve a certain topic (e.g., based on keywords, forum topics, hashtags, and so on).

“Behavior,” on the other hand, relates to how the viewers responded to the content, such as with regard to issues (which issues audiences identified in the content), social context (what was the social/conversation data, and issue context), actions (what actions did audiences take on those issues), propensity analysis (“PSM” to identify specific role, described below), etc. Primary data sources for scale may consist illustratively in purchased or donated viewership data from companies including all box office, TV viewers, DVD sales, and estimated streaming views on every property, while behavior can be learned through representative consumer surveys and survey instruments developed with expert academic partners and consultants. In general, behavior tracking may be used to quantify word-of-mouth moments (e.g., why users might want to see a first film (entertaining), but not perform an action (too difficult), while they might also want to avoid seeing a second film (e.g., too disturbing), but will take the associated action (e.g., simple)).

An example survey may generally consist of a 25- to 30-minute survey length (e.g., including all screening and demographic questions), where respondents are asked a battery of questions for each of a number (e.g., three) separate titles from the list, with those titles assigned to qualified respondents to titles according to greatest need. For example, respondents may be ages 18+ (e.g., proportional based on census), a 50/50 gender split, and have an ethnic representation based on census. In addition, the respondents may be screened-out for media industry respondents. In one embodiment, the survey is an online audience survey, while in another embodiment, manual surveying may be accomplished. The survey gathers and reports key data—and offers opportunities for additional data analysis, and may be on an ongoing basis, or else may be performed a few times a year (e.g., three instances or “waves” a year).

In one embodiment, the TPI model may be limited to a maximum of thirty entertainment titles for each “wave” of research. In particular, a list that is longer than thirty properties can increase the expense exponentially, given the need to over-sample for audiences of entertainment properties with smaller audiences sizes.

For each wave of TPI, the following criteria may be used to select particular entertainment properties (and to not select others):
Timing: For example, released within the last calendar year (preferably released at least 2-3 months prior to the research);
Audience: For example, reasonable expectation for an audience to have seen the property (i.e., release/distribution not limited to fewer than three markets, etc.);
Issue-based: For example, core storyline being focused on an identifiable social issue (e.g., women in media, young people, etc.), to issue an associated report.

Note it may also be helpful to include a list of entertainment properties that can act as a “control group” (i.e., properties that have limited social-impact narratives and impact potential, such as large blockbuster action films, etc.) in order to have a relative basis of comparison with the social-issue-focused properties.

Note also that the research results may be iterative, combinatory, independent, overlapping, and so on. Also, each instance of TPI computation may be used in the generation of future questionnaires, and to correspondingly shape future campaigns and gauge the state of audience interest in core social issues.

In general, the surveys may contain any number of useful and desired questions, including standard demographic questions. For example, when questioning about particular titles or properties, the survey may specifically call out whether the participants have seen the properties, how long ago it was since they've seen it, how they saw it (e.g., theater, TV, internet, etc.), and so on. Other examples or questions or ratings may include overall assessment of the property (e.g., it sticks in my mind, it's entertaining, it's humorous, it's informative, it's irritating, it's boring, it's confusing, it tells me something new, it's the sort of video I'd talk about with my peers, I can identify with what it is saying and showing, it discusses and addresses important issues, it tells me something interesting, it shows the importance of the topic, etc.). Also, certain specific questions relating to particular properties may help augment the TPI-related data. For example, where a documentary about teaching is presented, specific questions or statements (e.g., ratings, checkboxes, or ranges (agree/disagree)) may comprise such things as: teachers can inspire and change their student's lives, teaching in the U.S. needs to be improved, there is a misperception about what it means to be a teacher, there is a misperception about how difficult it is to be a teacher, teaching gets the respect it deserves, teaching is a profession I am proud to be in or I am proud to go into, teaching is a respected occupation, etc.

TPI's “emotions” survey question asks viewers whether they experienced one of five key emotions watching the entertainment title in question: anger, fear, disgust, happiness/joy, sadness. This survey question comes from and was inspired directly by the following source: Murphy, S. T., Frank, L. B., Moran, M. B., & Patnoe-Woodley, P. (2011). Involved, transported, or emotional? Exploring the determinants of change in knowledge, attitudes, and behavior in entertainment-education. Journal of Communication, 61, 407-431.

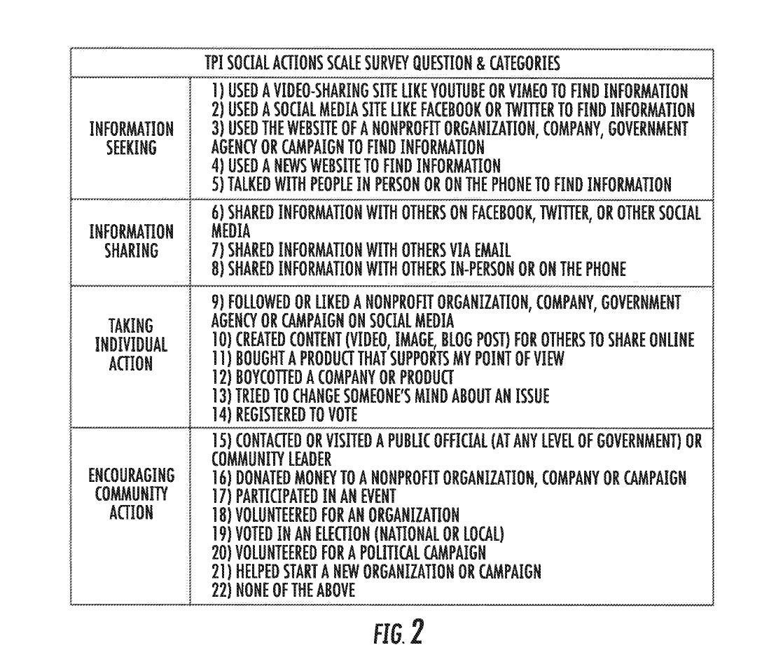

TPI's “social actions scale” asks viewers to indicate the kinds of actions they have taken (on a core social issue) after viewing each entertainment title. With reference to FIG. 2, the scale illustratively includes 21 individual responses across four categories, moving from individual to collective action taken both online and offline. Illustratively, such categories and questions may comprise:
Information Seeking
   Used a video-sharing site like YouTube or Vimeo to find information
   Used a social media site like Facebook or Twitter to find information
   Used the website of a nonprofit organization, company, government agency or campaign to find information
   Used a news website to find information
   Talked with people in person or on the phone to find information
Information Sharing
   Shared information with others on Facebook, Twitter, or other social media
   Shared information with others via email
   Shared information with others in-person or on the phone
Taking Individual Action
   Followed or liked a nonprofit organization, company, government agency or campaign on social media
   Created content (video, image, blog post) for others to share online
   Bought a product that supports my point of view
   Boycotted a company or product
   Tried to change someone's mind about an issue
   Registered to vote
Encouraging Community Action
   Contacted or visited a public official (at any level of government) or community leader
   Donated money to a nonprofit organization, company or campaign
   Participated in an event
   Volunteered for an organization
   Voted in an election (national or local)
   Volunteered for a political campaign
   Helped start a new organization or campaign
   None of the above

An early version of the TPI social actions scale was developed and inspired by an “activism orientation scale” from this source: Corning, A. F. & Myers, D. J. (December 2002). Individual Orientation toward Engagement in Social Action. Political Psychology, Vol. 23, No. 4 (December 2002), pp. 703-729, published by the International Society of Political Psychology.

In general, the greater the narrative involvement with a story, the more likely viewers are to respond with action; the questions that comprise the “narrative involvement” question in the TPI survey are adapted from the following original source (although this scale—and adaptations—have been used in may published and other works over the past 15 years: Green, M. C. and Brock, T. C. The Role of Transportation in the Persuasiveness of Public Narratives. Journal of Personality and Social Psychology, 2000. Vol. 79, No. 5: 701-721. For example, the three in 10 viewers who say a particular title “changed my life” (from the Green & Brock narrative transportation scale) are more likely to engage in a wide variety of social actions.

Of course, participants answering these questions may also enter “other” or “none,” which could also be useful when examining the social impact of media. Note that the nineteen actions above relating to social behavior are merely examples, and any set of actions may be used to generate the behavior list (and the associated weights, as described below). In other words, the question: “Which of the following did you do related to the topic of the issue being analyzed based on watching the content of the property of interest may have other selectable answers than those specifically mentioned herein.

Notably, because the it is based on understanding the “social actions” an audience member takes on an identifiable social issue that is the focus of an entertainment property, TPI does not measure the impact of entertainment properties that are not connected to identifiable, relevant public social issues. This is important to understand now and in the future, as it directly relates to the selection of entertainment properties to be used in each instance (or “wave”) of TPI. That is, including entertainment properties that are not focused on a core social issue is ineffective and meaningless; according to TPI's design, no “effect” of the entertainment will be found, since the “effect” is based on social actions taken on a social issue as a result of seeing the property.

In particular embodiments, where possible, a technique called Propensity Score Matching (PSM) may be used to assist in determining truth versus relevance in the survey results. Propensity score matching is a technique used by statisticians to help correct for bias in surveys when a true randomized field experiment is not possible. The core idea, then, is related to experimental research design: The analyst first builds a model that helps predict the propensity for a person to have received the “treatment” (in this case, the “treatment” is seeing a particular entertainment property) then that model is used to help better compare similar respondents that are both “treated” and “untreated” (here, that means “seen property” or “not seen property”). The propensity score model is built using specific variables in a survey.

Said differently, in clinical studies, randomized trials or pre-post studies are often utilized to avoid selection bias. However, random assignment or pre-post data collection is not always practical—especially with mass media campaigns. Propensity score matching (PSM) is a method of statistical analysis that controls for simple selection bias in studying the effect of exposure to a treatment or intervention: in the case of a media campaign, the “intervention” may be a feature film, a TV episode, a billboard, a pamphlet, a PSA, a news report, or other type of property, etc.

The first phase of PSM entails finding the factors that would predict the likelihood of a subject being exposed to the intervention: these factors may be demographic, ideological, behavioral, etc. Using logistical regression, the techniques herein use a model based upon those predictors. In the second phase, subjects are assigned propensity scores: subjects who were not exposed to the intervention are compared with subjects with the same propensity score who were exposed. In the studies herein, the desired results show differences in knowledge, attitudes, and behavior based upon exposure to the intervention.

Notably, the results of each TPI instance or “wave” may result in a different set of data points and adjusted absolute values for scoring, whether due to participant differences (assuming a non-representative data set), organic shift in absolute numerical values in the “scoring,” given that scoring is relative to the other entertainment titles behind examined, or, more likely, due to changes in opinion over time (e.g., social changes, time elapsed since viewing property, etc.) As such, the results may change for each TPI instance performed, and thus its relevance may, under certain analysis, need to be limited to the particular instance. (Note, the change in results, and thus TPI as described below, may also be a valuable data point.)

With specific regard to the techniques herein, TPI has developed a new way to assess and articulate an individual entertainment title's overall “social impact.” Based on survey data, TPI defines and articulates the levels of “TPI Social Impact” as the combination of two measures: (1) the emotional connection (narrative involvement) of an audience to an individual entertainment title, and (2) the social actions audiences take on a core social issue covered in a piece of entertainment, after viewing.

The core TPI is computed based combining two elements (each on a score from 0-100): 1) the Narrative Involvement Scale, and 2) the Social Actions Scale.

First, the Narrative Involvement Scale (this concept and the precise survey questions that measure it comes from: Green, M. C. and Brock, T. C. The role of transportation in the persuasiveness of public narratives. Journal of Personality and Social Psychology, 2000. Vol. 79, No. 5: 701-721.) measures the emotional and narrative impact a film, program, or video has—how relevant, emotionally impactful, hard to forget, etc., viewers find it. Illustratively, the techniques herein assign a score of 100 to the title that rates as most emotionally resonant on this scale, then distribute the rest of the scores proportionally, meaning that the higher the figure, the more impactful that title is relative to other titles tested on this metric. In particular, the metric may be based on a particular survey question, such as a series of agree-disagree statements on the narrative impact of a title, and is built based on the average agreement rating on a 1-5 scale (e.g., normalized, setting the highest-performing title to 100 and distributing scores for all other titles proportionally). In general, this implies that the higher the score (with 100 as the maximum) the greater emotional and narrative impact a title has—viewers find it relevant, emotionally impactful, hard to forget, etc.

Said differently, the TPI narrative involvement scale measures the extent to which an audience experiences an emotional connection to a piece of entertainment. Through a public opinion survey, this is measured by asking respondents to characterize their emotional connection to an entertainment title's story through a “narrative involvement scale” that includes such things as:
I found myself thinking about how I would have responded to a situation presented in this film/TV show/video.
This film/TV show/video is relevant to my everyday life.
This film/TV show/video affected me emotionally.
Afterwards, I found this film/TV show/video difficult to put out of my mind.
This film/TV show/ video changed my life.

Second, the Social Actions Scale (an early version of this scale was derived from: Corning, A. F. & Myers, D. J. (December 2002). Individual Orientation toward Engagement in Social Action. Political Psychology, Vol. 23, No. 4 (Dec., 2002), pp. 703-729, published by the International Society of Political Psychology.) measures the degree to which a title inspires viewers to act in some way, whether in seeking or sharing information, taking individual action, or encouraging communal action. Emphasis is on the volume of activities engaged in, and in one embodiment slightly more weight may be given to those activities that demonstrate the greatest potency—i.e. how many other activities are also engaged in when viewers do that one thing. Again, the techniques herein may illustratively assign a score of 100 to the top-performing title, and distribute the rest of the scores proportionally. In general, this metric may be based on a particular different question in a survey, recording the number of political and social activities inspired by viewing the title. For instance, the social actions scale asks viewers to indicate the types of actions they have taken (on a core social issue) after viewing each title. The scale illustratively includes the 21 individual responses across four categories, moving from individual to collective action taken both online and offline, as described with reference to FIG. 2 above, by way of non-limiting example. Activities with the greatest potency may be given slightly stronger weighting to reflect their relative importance. Here again, the techniques normalized results with 100 as the highest point on the scale. (Note that those activities that are accompanied by the most other activities may be given slightly more weight, reflecting a sense that the more a viewer is moved to action—and the more actions he or she is moved to—the better.) Similar to above, the higher the score (with 100 as the maximum) the greater behavioral impact a title has—viewers are spurred to action on multiple fronts.

The scores for these two elements may then be averaged to produce the Social Impact Score (again on a 0-100 scale). Because this metric combines both emotional and behavioral impact, the score reflects a breadth of strength—the higher the figure, the more impactful the title. In other words, each title's scores on the TPI Social Impact Scale and the TPI Narrative Involvement Scale may be averaged together to produce a TPI Social Impact Score (again on a 0-100 scale), i.e., TPI Narrative Involvement Score+TPI Social Actions Score/2 (average)=TPI Social Impact Score. The expression of this scoring system is an example of a scoring and public recognition system, and it may change over time or based on the objectives of the project.

Notably, the use of a 100-point scale is merely one example, and any appropriate scale may be used (e.g., 1-10, 1-50, etc.). In general, the scale is meant to give comparative meaning amongst titles that are readily recognizable by observers, such as a conventional 100-point or 10-point scale, rather than obscure numbers such as trying to compare 0.2452 vs. 0.2419. Also, in an alternative embodiment, a specific value need not be assigned as the top score based on the highest scoring title, but rather the actual scores from the data may be used as a direct comparison. Furthermore, the scores may be based on individual waves (e.g., comparing only those titles within a single wave), or else may be compared (and ranking adjusted) based on a plurality of waves (i.e., increasing the number of titles that are compared to determine a “highest” scoring title). In this manner, a determination may be made over time of what a true “high” score is when compared to other titles.

“Buzz” Creation, on the other hand, represents the ratio of social conversation created (FIG. 1) (e.g., as determined using web crawler data) for every view of that title (illustratively as determined using box office figures, television ratings, and web traffic reporting). It is designed to provide a measure of both a title's reach and its potency as a conversation-starter. In general, the higher the score, the greater buzz creation a title has—that is, those who see the program are moved to talk about it via social media. Note that because this metric is tied to total viewership, titles with the higher viewership have the highest bar to clear—for instance, a program with 165 million views, would need to inspire many more social media conversations than a less-viewed film having 6000 views in order to have the same “Buzz” Creation rating. As a result, on this metric, documentaries and other programs that naturally spur reflection/conversation will outperform much of episodic television.

As a companion to the TPI Social Impact Score, the techniques herein also define a tiered Social Impact Rating system. This system classifies titles based on their TPI Social Impact Score, with a top tier (“highest rating”), illustratively composed of those titles that rate a 90 or above in this summary score, followed by the rating levels “highest” (70-89.9), “high” (50-69.9), and “low” (below 50). The goal of this rating system is to provide users with an at-a-glance understanding of a given title's performance. Illustratively, such categories may be given a particular achievement classification, such as “gold”, “silver”, “bronze”, etc., as representing Highest, High, Medium, as follows in on non-limiting exemplary embodiment:

Gold (90 & above)—Entertainment titles that achieve the “Highest” rating achieve strong scores in both the TPI Narrative Involvement and TPI Social Actions scales. These titles deeply connect with viewers emotionally, and they also inspire a high level of social action. Viewers who see these titles may engage in a weighted average of 5.3 social actions (out of 19) as a result of watching by way of non-limiting example. The average Narrative Involvement score of these titles may be 96 and an average Social Actions score is 92.

Silver (70-89.99)—Entertainment titles that achieve a “High” rating have very high scores on one or the other of the TPI Narrative Involvement and TPI Social Actions scales, but not on both. These titles may connect with viewers emotionally or inspire social action, but not both. Viewers who see these titles may engage in a weighted average of 4.2 social actions as a result of watching, by way of non-limiting example. The average overall TPI Social Impact Score among these titles may be 82, with an average of 91 on Narrative Involvement, but 72 on Social Actions, by way of non-limiting example.

Bronze (50-69.9)—Entertainment titles that achieve a “Medium” rating tend to have significant emotional impact, but don't tend to inspire much social action. Viewers who see these titles may engage in a weighted average of 1.9 social actions as a result of watching, by way of non-limiting example. The average TPI Social Impact Score among these titles may be 58, with an average of 83 on Narrative Involvement, but 33 on Social Actions, by way of non-limiting example.

None or N/A (below 50)—Entertainment titles that achieve a “Low” rating tend to have little emotional impact, and don't tend to inspire much social action.

In general, the key findings that may be reported based on the techniques herein, including specifically the TPI and associated indexing values, focus on the relationship between social issues, emotional involvement in entertainment, and social actions the audience is inspired to take after consuming entertainment.

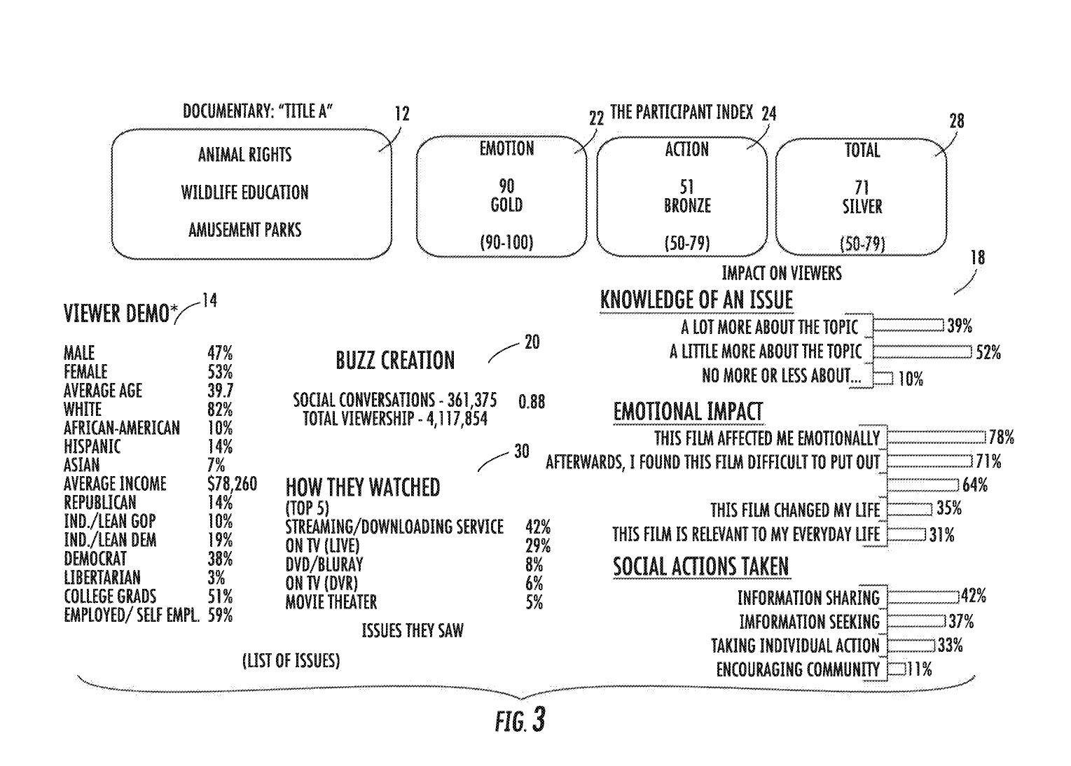

FIG. 3 illustrates an example of a report that may be generated for a specific documentary title (e.g., “TITLE A”) based on the techniques herein. (Note that the particular format and information contained within the report is merely an example, and is not meant to limit the scope of the embodiments herein.) As shown in FIG. 3, TITLE A identifies the title and may relate to animal rights, wildlife education, or amusement parks by way of non-limiting example as identified in section 12. The collected statistics may show the view demographics (e.g., male/female, average age, etc.), and be presented in a Viewer Demo section 14, and how the viewers saw the content (e.g., on TV, DVD, etc.), and presented in a How They Watched section 30. The survey results may also demonstrate the issues that the viewers saw (for example, the intended issues, not all the intended issues, issues not originally intended, and so on) which is presented in an Issues They Saw section 16. The impact on viewers, such as increasing or decreasing their knowledge on a subject, their emotional image, and their social actions taken may be presented, as well in an Impact on Viewers section 18. As described in greater detail above, the Buzz Creation section 20 may show that of a certain total viewership (e.g., 4+MM), that a certain number of social conversations (e.g., 360+thousand) resulted in a buzz creation factor of 0.88 in a Buzz Creation section 20. Lastly, the TPI achievement classifications (social impact rating system) may be separated for the narrative involvement scale (“Narrative Involvement” Gold or Highest rating of 90), in an EMOTION section 22, social action scale (“Action” Bronze or Medium rating of 51) in an ACTION section 24, and a total social impact score (“total” Silver or High rating of 71) in a TOTAL section 26.

Note that for each entertainment title, the viewership totals reflect particular date parameters. Specifically, viewership data for properties shows estimated totals from release/premiere of the film title or specific show's season to six months following the premiere/release. Over time, full viewership totals may be tracked over the course of a full year after release/premiere of the examined entertainment titles as a way to assess patterns and the full impact of the “life cycle” of an entertainment title from TV/theater/online through DVD and video-on-demand phases, etc.

Also, to gather information about the conversations happening online around each of the studied entertainment titles, an external Web crawler may be used with unique search terms for each title (where the logic of the searches is consistent from title to title), including the unique identifiers of title, genre, actors or notable names, studio or network, etc. For each entertainment property, the number of social media conversations may be gathered for a set period (e.g., a maximum of 12 months of data for each property—six months prior to premiere and six months following its premiere/release). The Web crawler “conversations” total may illustratively include various sources of information such as: blogs, comments, news, forums, reviews, and Twitter® by way of non-limiting example. Additionally, when possible, the total may include conversations on Facebook®, Instagram®, and Google Plus®, by way of non-limiting example. For online videos, the total may include the number of YouTube comments. Note that the Web crawler conversations total may include coverage and conversations in English, and in the United States only, although the tool may be configured to support non-English language and a global view not bound by geography of the viewers.

Additionally, the techniques herein allow for a user to dive more deeply into the kind of questions and trends that TPI can reveal, unleashing stories from data. For example, who takes social action? (What are the profiles of those users?) What kinds of entertainment properties encourage social action? (Examination of properties and action profiles.) What are the key differences between media genres (narrative film, doc film, reality TV, short video) and social action? How is this data useful, such as for shaping acquisitions and action campaigns, as well as market-based targeting? To prepare the “deeper dive” and “data stories”, particular strategic data analysis points may be accumulated and presented, such as:
Creating profiles of media-consumers and action takers (based on political valence, organizational types and membership, demographics)
   What are the differences between each of these groups?
   Which properties drew different types of action takers?
Analyzing how the different properties stack up against each among different demographics
   What were the properties that were popular among each age, income, ethnic, and political partisanship groups?
Beyond just activists, what films made the most impact on viewers' thinking about the issues?
On which properties could viewers most accurately identify the key issues?

Generally, there is a difference between documentary film and docu-reality TV that emphasizes individual behavior and individual solutions to a social issue show the greatest impact in the question: “Does X title have an impact on viewers'social actions on an issue?” Also, there are notable differences between documentary & narrative projects. Taken as a whole, the major differences in PSM-observed effects can be seen between documentary TV/film (including docu-reality) and narrative film; medium (i.e., TV vs. film) wasn't necessarily the key difference.

Note that in one embodiment, it may be possible to account for survey bias that may create anomalies by splitting the respondent pool: One pool will be “documentary” viewers, and one pool will be “pop culture narrative viewers.” In this way, one can look more closely at the differences in impact between narrative films that do have a social issue/impact message versus those that do not, in order to compare narrative film against narrative film.

The results also show that storytelling that emphasizes “individual-level action can change things” shows individual impact, while storytelling that emphasizes complex institutional problems and solutions does not. Starting with the premise that this kind of quantitative research method is able to make conclusions about individual actions and behaviors, it makes sense that the kinds of projects that showed impact (again, “impact” here is articulated as individual action) are the ones that have a strong narrative message about individual self-efficacy, or the idea that one person is able to take an action that can help a situation. The concept of self-efficacy is the cornerstone of individual behavior-change communication, and one of the most important routes to self-efficacy, as proven by many social scientists in psychology and communication, is “social modeling”—watching and learning the specific ways to do something. Conversely, the other side of the individual self-efficacy concept is presenting entertainment projects that show deep institutional problems that are dire, complex, and thus perhaps seemingly hopeless from an individual behavior (or “action”) perspective. While these projects are obviously valuable, regardless of this particular research method, it might be expected that we wouldn't necessarily see “individual-level impact” from entertainment properties that are not depicting “individual-level self-efficacy,” or the idea that you, the viewer, can do something right now that will help change this situation. In other words, relying solely on individual-level quantitative research to examine the impact of narratives that do not include “individual behavior solutions” may not be the right research choice.

Generally, the applications or processes described herein can be implemented as a series of computer-readable instructions, embodied or encoded on or within a tangible data storage medium, that when executed are operable to cause one or more processors to implement the operations described above. While the foregoing processes and mechanisms can be implemented by a wide variety of physical systems and in a wide variety of network and computing environments, the computing systems described below provide example computing system architectures of the server and client systems described above, for didactic, rather than limiting, purposes.

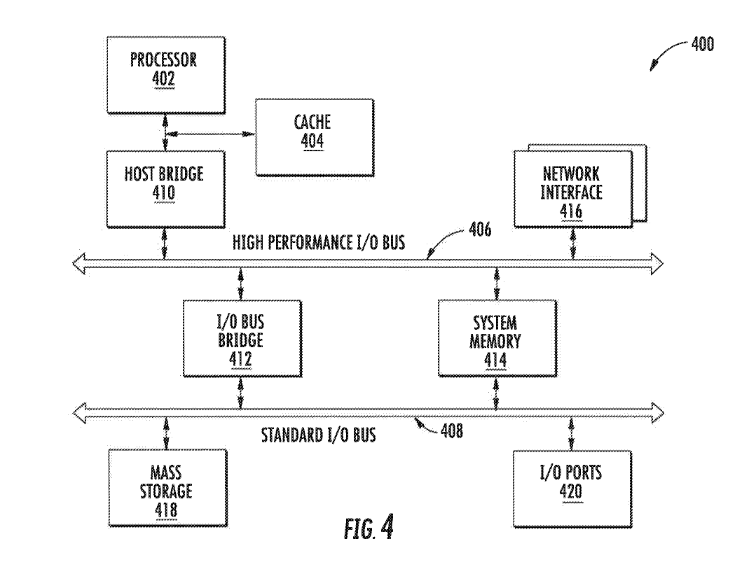

FIG. 4 illustrates an example computing system architecture, which may be used to implement a server, a client device, etc. In one embodiment, hardware system 400 comprises a processor 402, a cache memory 404, and one or more executable modules and drivers, stored on a tangible computer readable medium, directed to the functions described herein. Additionally, hardware system 400 includes a high performance input/output (I/O) bus 406 and a standard I/O bus 408. A host bridge 410 couples processor 402 to high performance I/O bus 406, whereas I/O bus bridge 412 couples the two buses 406 and 408 to each other. A system memory 414 and one or more network/communication interfaces 416 couple to bus 406. Hardware system 400 may further include video memory (not shown) and a display device coupled to the video memory. Mass storage 418, and I/O ports 420 couple to bus 408. Hardware system 400 may optionally include a keyboard and pointing device, and a display device such as a graphical user interface (not shown) coupled to bus 408. Collectively, these elements are intended to represent a broad category of computer hardware systems, including but not limited to general purpose computer systems.

The elements of hardware system 400 are described in greater detail below. In particular, network interface 416 provides communication between hardware system 400 and any of a wide range of networks, such as an Ethernet (e.g., IEEE 802.3) network, a backplane, etc. Mass storage 418 provides permanent storage for the data and programming instructions to perform the above-described functions implemented in the servers or client devices, whereas system memory 414 (e.g., DRAM) provides temporary storage for the data and programming instructions when executed by processor 402. I/O ports 420 are one or more serial and/or parallel communication ports that provide communication between additional peripheral devices, which may be coupled to hardware system 400.

Hardware system 400 may include a variety of system architectures; and various components of hardware system 400 may be rearranged. For example, cache 404 may be on-chip with processor 402. Alternatively, cache 404 and processor 402 may be packed together as a “processor module,” with processor 402 being referred to as the “processor core.” Furthermore, certain embodiments of the present invention may not require nor include all of the above components. For example, the peripheral devices shown coupled to standard I/O bus 408 may couple to high performance I/O bus 406. In addition, in some embodiments, only a single bus may exist, with the components of hardware system 400 being coupled to the single bus. Furthermore, hardware system 400 may include additional components, such as additional processors, storage devices, or memories.

In one implementation, the operations of the embodiments described herein are implemented as a series of executable modules run by hardware system 400, individually or collectively in a distributed computing environment. In a particular embodiment, a set of software modules and/or drivers implements a network communications protocol stack, browsing and other computing functions, optimization processes, and the like. The foregoing functional modules may be realized by hardware, executable modules stored on a computer readable medium, or a combination of both. For example, the functional modules may comprise a plurality or series of instructions to be executed by a processor in a hardware system, such as processor 402. Initially, the series of instructions may be stored on a storage device, such as mass storage 418. However, the series of instructions can be tangibly stored on any suitable storage medium, such as a diskette, CD-ROM, ROM, EEPROM, etc. Furthermore, the series of instructions need not be stored locally, and could be received from a remote storage device, such as a server on a network, via network/communications interface 416. The instructions are copied from the storage device, such as mass storage 418, into memory 414 and then accessed and executed by processor 402.

An operating system manages and controls the operation of hardware system 400, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft®, Windows® operating systems, BSD operating systems, and the like.

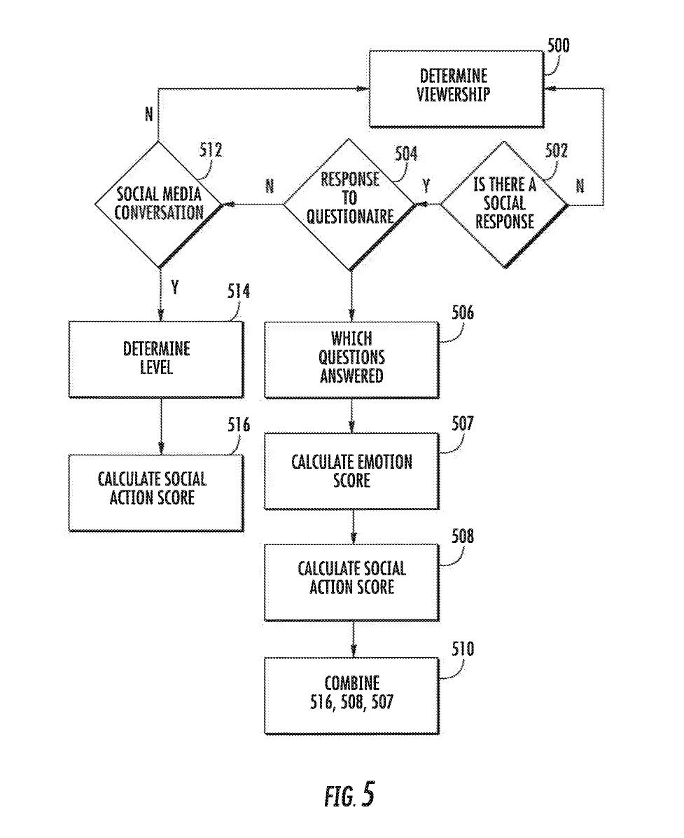

Reference is now made to FIG. 5 in which a method for determining total participation index in accordance with one exemplary non-limiting embodiment is provided. In a step 500 the number of viewers of the Project is determined. Then in a step 502, it is determined whether there was some type of social response to the project. In a preferred non-limiting embodiment, as described above, a questionnaire may be provided to each viewer and the social response may be considered the answering of the questionnaire. If there are no answers to the questionnaire, then the process returns to determining viewership in a step 500. However, if there is a response to the questionnaire in a Step 504, a determination is made as to which questions were answered in a Step 506. As discussed above, a subset of the questions which are answered are each provided a respective numerical value as a function of the answer. One example may be how strongly a viewer feels about a concept on a graded scale of 1 to 5 after viewing the project. In Step 507 a Total EMOTION score is calculated as a function of the number of questions answered and the number of people answering those questions.

In a Step 508 a SOCIAL ACTION score is calculated as a function of the respective graded scores to each question. One embodiment for determining a Social Action score may be a process as simple as combined score of all of the graded scores to the questions. In other embodiments, the answers may be given weight as a function of the importance of the question to the SOCIAL ACTION. If there was no response to the questionnaire in Step 504, and/or in addition to the response to the questionnaire, it is determined whether a SOCIAL RESPONSE has occurred. In a Step 512, by way of example, is determined whether a SOCIAL MEDIA conversation has occurred in response to the project. If not, the process is returned to Step 500 to determine viewership and begin again.

If a SOCIAL MEDIA conversation has occurred, then in a Step 514, as a function of monitoring key words, the level of SOCIAL MEDIA conversation is determined. In a Step 516, a SOCIAL ACTION score may also be determined as a function of the level of SOCIAL MEDIA conversation determined in the previous steps in this non-limiting embodiment as a function of monitoring the SOCIAL MEDIA traffic for particular actions, key words and the like.

In a Step 510, the SOCIAL ACTION score determining Step 508 is combined with the SOCIAL ACTION score determining step 516 to calculate an overall SOCIAL ACTION score. This combined score is then combined with the total EMOTION score determined in Step 507 for an overall total participation index score. One such combination may be a simple even weighting of adding the two scores and dividing by 2. Other weighting methodologies may be used. It should be noted, that the determination of total SOCIAL ACTION score and the determination of the total EMOTION scores may occur in parallel tracks and need not be in the specific order of FIG. 5. FIG. 5 is by way of example of a non-limiting chronology. Furthermore, calculating total SOCIAL ACTION score as a function of questionnaire answers and/or SOCIAL MEDIA response may be done simultaneously, or one before the other in either order.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

In particular, the foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible (non-transitory) computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. By way of example, while embodiments of the present invention have been described as operating in connection with a social networking website, the present invention can be used in connection with any communications facility that supports web applications. Furthermore, in some embodiments the term “web service” and “web-site” may be used interchangeably and additionally may refer to a custom or generalized API on a device, such as a mobile device (e.g., cellular phone, smart phone, personal GPS, personal digital assistance, personal gaming device, etc.), that makes API calls directly to a server.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for determining social response to a property comprising the steps of:
determining a total emotion score as a function of viewing the project;
determining a social action score as a function of viewing the project;
determining a total participation index score as a function of the total emotion score and the total social action score, the total participation index indicating the social response to the property as a numerical value.

2. The method of claim 1, wherein the total emotion score is a function of the number of viewers of the project which respond to a project related request.

3. The method of claim 2, wherein the project related request is to respond to a set of questions.

4. The method of claim 1, further comprising the step of determining a social action as a function of a subset of the responses to the plurality of questions.

5. The method of claim 4, wherein a response to each question in the subset of questions is assigned a score as a function of a content of the response to a respective question.

6. The method of claim 5, wherein the total social action score is a function of the scores.

7. The method of claim 1, further comprising the step of monitoring a social media commentary for at least one key word, the social action score being a function of the occurrence of the key word in the social media commentary.

8. The method of claim 2, further comprising the step of providing the questions to a second group of viewers, at a time spaced in time from the providing the questions to a first group of viewers; and
calculating the total action score as a function of the response of a first group of viewers and a response of the second group of viewers.
